(19) United States
(12) Patent Application Publication
(10) Pub. No.: US 2009/0164391 A1
(43) Pub. Date: Jun. 25, 2009

(54) Self learning method and system to revenue manage a published price in a retail environment

(75) Inventors: Jonathan Otto, Palm Beach, FL (US); Andrew Van Luchene, Santa Fe, NM (US); Raymond J. Mueller, Palm Beach Gardens, FL (US); Michael R. Mueller, San Francisco, CA (US)

Correspondence Address: SIMPSON & SIMPSON, PLLC, 5555 MAIN STREET, WILLIAMSVILLE, NY, 14221-5406, US

(73) Assignee: RetailDNA, LLC, Lake Worth, FL (US)

(21) Appl. No.: 12/231,816

(22) Filed: Sep. 5, 2008

Related U.S. Application Data
(63) Continuation-in-part of application No. 12/151,043, filed on May 2, 2008.
Application No. 12/151,043 is a continuation-in-part of application No. 11/983,679, filed on Nov. 9, 2007.
Application No. 11/983,679 is a continuation-in-part of application No. 09/993,228, filed on Nov. 14, 2001.

(51) Int. Cl. G06Q 30/00; G06Q 10/00; G06F 15/18; G06F 17/00

(52) U.S. Cl. 705/400; 705/10; 706/16; 706/45

(57) ABSTRACT

A computer-based self-learning system for managing a price in a retail environment, including: an interface element for at least one specially programmed general-purpose computer for receiving an input related to initiation of a transaction between a customer and a first business entity; a memory unit for the at least one specially programmed general-purpose computer for storing an artificial intelligence program (AIP) and a history of at least one previous transaction between the customer and the first business entity; and a processor for the at least one specially programmed general-purpose computer for: determining, using the AIP, the input, and the history, a price for the good or service to optimize revenue for the first business entity or profitability of the first business entity. The interface element is for receiving a request for the price, and the processor is for transmitting, using the interface element, the price for display.

### CROSS-REFERENCE TO RELATED APPLICATIONS

This is a continuation-in-part patent application under 35 USC 120 U.S. patent application Ser. No. 12/151,043, filed May 2, 2008 and entitled “Method and System For Centralized Generation of a Business Executable Using Genetic Algorithms and Rules Distributed Among Multiple Hardware Devices,” which is a continuation-in-part of U.S. patent application Ser. No. 11/983,679, filed Nov. 9, 2007 and entitled “Method and System for Generating, Selecting, and Running Executables in a Business System Utilizing a Combination of User Defined Rules and Artificial Intelligence” which is a continuation-in-part patent application under 35 USC 120 of U.S. patent application Ser. No. 09/993,228, filed Nov. 14, 2001 and entitled “Method and apparatus for dynamic rule and/or offer generation,” which applications are incorporated herein by reference.

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to a self-learning method and system for automatically and intelligently managing pricing in a retail environment.

### BACKGROUND OF THE INVENTION

It is known to provide a dynamically generated menu, for example, as disclosed in U.S. Published Patent Application No. 2002/0032667, which application is incorporated by reference herein. Unfortunately, the preceding application does not disclose the use of self-learning

Thus, there is a long-felt need to provide a self-learning system and a method for automatically and intelligently managing pricing in a retail environment.

### SUMMARY OF THE INVENTION

The invention broadly comprises a computer-based self-learning system for managing prices in a retail environment, including: an interface element for at least one specially programmed general-purpose computer for receiving an input related to initiation of a transaction between a customer and a first business entity; a memory unit for the at least one specially programmed general-purpose computer for storing an artificial intelligence program (AIP) and a history of at least one previous transaction between the customer and the first business entity; and a processor for the at least one specially programmed general-purpose computer for: determining, using the AIP, the input, and the history, a price for the good or service to optimize revenue for the first business entity or profitability of the first business entity. The interface element is for receiving a request for the price, and the processor is for transmitting, using the interface element, the price for display.

In one embodiment, the processor is for optimizing revenue or profitability for the first business entity with respect to a selectable metric stored in the memory element. In another embodiment, the processor is for selecting the metric using the AIP and storing the metric in the memory element. In a further embodiment, the input includes a parameter regarding the customer or a parameter regarding operation of the first business entity.

In one embodiment, the history of transactions includes at least one previous price modification for the good or service and the processor is for determining, using the AIP, optimization, with respect to the at least one previous price modification, of revenue for the first business entity or of profitability of the first business entity. In another embodiment, the processor is for determining, using the input and the AIP, a classification of the customer, and determining the price using the classification. In a further embodiment, the processor is for generating or modifying, using the AIP, a presentation for the price, and transmitting, using the interface element, the data regarding the presentation to the display device.

In one embodiment, the processor is for: receiving, using the interface element, at least one rule from a wireless communications device (WCD) or from a general-purpose computer associated with a second business entity; storing the at least one rule in the memory element; and modifying the price using the at least one rule. In another embodiment, the first and second business entities are the same. In a further embodiment, a WCD with a processor and a memory element is arranged to receive the price and the processor for the WCD is for: storing at least one rule in the memory element for the WCD; and executing, using the processor in the WCD, display of the price according to the at least one rule.

The invention also broadly comprises a method for managing prices in a retail environment.

It is a general object of the present invention to provide a self-learning system and a method for automatically and intelligently managing pricing in a retail environment.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for managing a price in a retail environment; and,

FIG. 2 is a flow chart of a present invention method for managing a price in a retail environment.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

It should be understood that the use of “or” in the present application is with respect to a “non-exclusive” arrangement, unless stated otherwise. For example, when saying that “item x is A or B,” it is understood that this can mean one of the following: 1) item x is only one or the other of A and B; and 2) item x is both A and B. Alternately stated, the word “or” is not used to define an “exclusive or” arrangement. For example, an “exclusive or” arrangement for the statement “item x is A or B” would require that x can be only one of A and B.

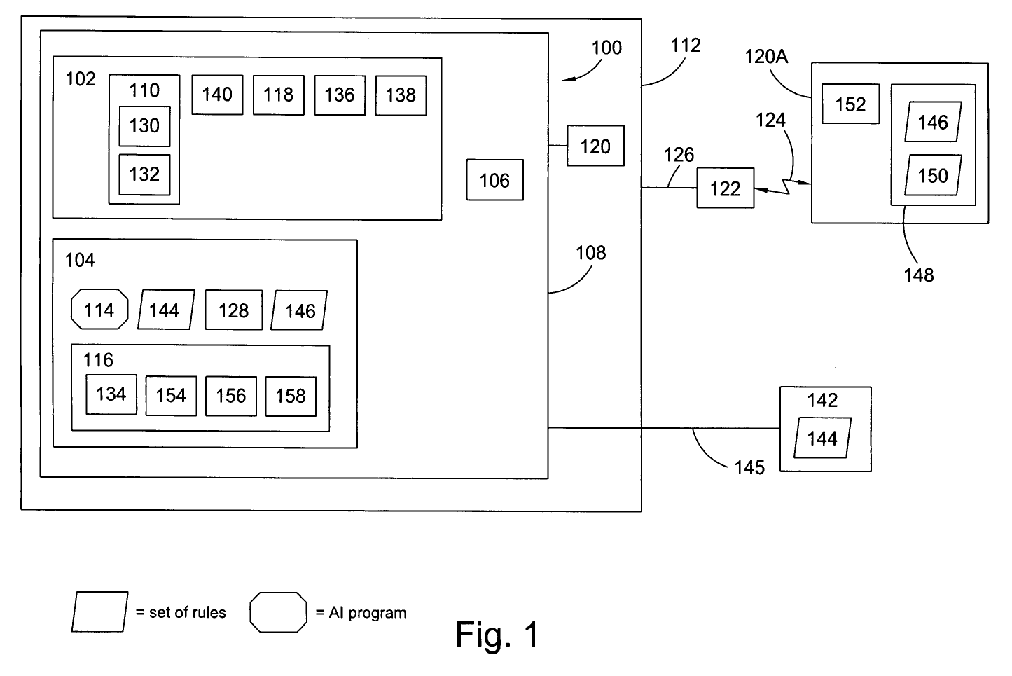

FIG. 1 is a schematic block diagram of present invention computer-based self-learning system 100 for managing a price in a retail environment. The system includes processor 102, memory element, or unit, 104, and interface element 106 in at least one specially programmed computer 108. The interface element is for receiving input 110 related to initiation of a transaction between a customer (not shown) and a first business entity, for example, the business entity associated with location 112. Artificial intelligence program (AIP) 114 and history 116 of at least one previous transaction between the customer and the first business entity are stored in the memory unit. In one embodiment, the processor determines, using the AIP, the input, and the history, price 118 for a good or service (not shown) to optimize revenue for the first business entity or profitability of the first business entity. In another embodiment, the processor determines, using the AIP and the input, price 118 to optimize revenue for the first business entity or profitability of the first business entity. The interface element is arranged to receive a request for price 118 and the processor transmits, using the interface element, the price. In one embodiment, the price is transmitted for display on a display device, for example, device 120 in location 112. In another embodiment (not shown), the price is transmitted to a printer and the price is printed out. Thus, using the AIP, the input, and the history, the processor is able to automatically, dynamically, and intelligently modify the price and modify the price according to performance data, as further described infra.

By interface element, we mean any combination of hardware, firmware, or software in a computer used to enable communication or data transfer between the computer and a device, system, or network external to the computer. The interface element can connect with the device, system, or network external to the computer, using any means known in the art, including, but not limited to a hardwire connection, an optical connection, an Internet connection, or a radio frequency connection. Processor 102 and interface element 104 can be any processor or interface element, respectively, or combination thereof, known in the art.

Computer 108 can be any computer or plurality of computers known in the art. In one embodiment, the computer is located in a retail location with which system 100 is associated, for example, location 112. In another embodiment (not shown), all or parts of the computer are remote from retail locations with which system 100 is associated. In a further embodiment, computer 108 is associated with a plurality of retail locations with which system 100 is associated. Thus, the computer provides the functionality described for more than one retail location.

Display device 120 can be any display device known in the art. In one embodiment, display device is a point of sales station, for example, a cash register, at which an employee of the business entity is working. In another embodiment, a customer places an order from a location remote from a location for the business entity, for example, location 112, using any means known in the art, for example, a remote kiosk (not shown) or a wireless communications device (WCD), for example, WCD 120A. A WCD is defined supra. WCD 120A can be any WCD known in the art. Commonly-owned and co-pending U.S. patent application Ser. No. 12/151,040, entitled “METHOD AND SYSTEM FOR MANAGING TRANSACTIONS INITIATED VIA A WIRELESS COMMUNICATIONS DEVICE”, filed May 2, 2008 is applicable to orders received from the WCD.

In one embodiment, price can be displayed on the following non-limiting examples of presentation devices:
1. On hand held devices controlled by the establishment.
2. On hand held devices controlled by the end user, for example, a WCD. In one embodiment, only registered users receive special prices on the hand held device.
3. On digital display signs or boards, for example at or near a business entity location.
4. On the drive through displays.
5. On a website requiring a user log in.
6. On a website that is publicly available.
7. On an in car navigation system in response to a request to go to a retail establishment.

In one embodiment, the first business entity is a restaurant, the price is part of a menu and the menu and price can be displayed on the following non-limiting examples of presentation devices:
1. On menus printed in real time.
2. On digital menu boards, for example, behind the counter of a cashier station at a quick serve restaurant.
3. On displays built into tables at the restaurant.
4. On the drive through menu board.
5. On a self-serve kiosk.

In one embodiment, WCD 120A is owned by, leased by, or otherwise already in possession of an end user when system 100 interfaces with the WCD. In the description that follows, it is assumed that the WCD is owned by, leased by, or otherwise already in possession of the end user when system 100 interfaces with the WCD. In general, the WCD communicates with a network, for example, network 122, via radio-frequency connection 124. Network 122 can be any network known in the art. In one embodiment, the network is located outside of the retail location, for example, the network is a commercial cellular telephone network. In one embodiment (not shown), the network is located in a retail location, for example, the network is a local network, such as a Bluetooth network. The interface element can connect with network 122 using any means known in the art, including, but not limited to a hardwire connection, an optical connection, an Internet connection, or a radio frequency connection. In the figures, a non-limiting example of a hardwire connection 126 is shown. In one embodiment, device 120A is connectable to a docking station (not shown) to further enable communication between device 120A and system 100. Any docking station or docking means known in the art can be used. That is, when the device is connected to the docking station, a link is established between the device and system 100.

In one embodiment, the processor optimizes revenue or profitability for the first business entity with respect to selectable metric 128 stored in the memory element. In another embodiment, the processor selects the metric using the AIP and stores the metric in the memory element. The metric can be, but is not limited to being, with respect to revenues, profits, item counts, average check, market basket contents, marketing offer acceptance, store visitation or other frequency measures, or improving or optimizing speed of service inventory levels, turns, yield, waste, enhancing or optimizing customer loyalty or use of kiosks or internet or other POS devices or self service devices, use of coupons or acceptance of marketing offers, reduction or optimization of any customer or cashier or any other person's gaming, fishing, or any other undesirable action or activities or failures to act when desired, minimizing or optimizing any dilution or diversion of sales, profits, average check, minimizing or optimizing use of discounts and other promotions so as to maximize or optimize any of the foregoing desired actions, outcomes or other desired benefits, or any combination of minimizing undesired results while maximizing or optimizing any one or more of any desired results. The metric also can be regarding considerations impacting the finances of the business entity, for example, check size, net or gross profit, or inventory reduction associated with transactions.

In one embodiment, the input includes parameter 130 regarding the customer or parameter 132 regarding operation of the first business entity. Parameter 132 can be, but is not limited to being, with respect to revenues, profits, item counts, average check, market basket contents, marketing offer acceptance, store visitation or other frequency measures, or improving or optimizing speed of service inventory levels, turns, yield, waste, enhancing or optimizing customer loyalty or use of kiosks or internet or other POS devices or self service devices, use of coupons or acceptance of marketing offers, reduction or optimization of any customer or cashier or any other person's gaming, fishing, or any other undesirable action or activities or failures to act when desired, minimizing or optimizing any dilution or diversion of sales, profits, average check, minimizing or optimizing use of discounts and other promotions so as to maximize or optimize any of the foregoing desired actions, outcomes or other desired benefits, or any combination of minimizing undesired results while maximizing or optimizing any one or more of any desired results.

In one embodiment, the history of transactions includes at least one previous price modification 134 for the good or service and the processor determines, using the AIP, optimization 136 of revenue for the first business entity or of profitability of the first business entity with respect to the at least one previous price modification. That is, the system automatically and dynamically adapts to the historical operations of system 100 or other systems to which system 100 has access. Alternately stated, the system self-learns from historic performance and data.

In one embodiment, the processor determines, using the input and the AIP, classification 138 of the customer, and uses the classification in determining the price, for example, as disclosed in commonly-owned U.S. patent application labeled: “METHOD AND SYSTEM FOR USING A SELF LEARNING ALGORITHM TO MANAGE A PROGRESSIVE DISCOUNT,” inventor Andrew Van Luchene, filed concurrently. In another embodiment, the processor generates or modifies, using the AIP, presentation 140 for the price, and transmits, using the interface element, the data regarding the presentation to the display device. That is, the processor determines the format, audio/visual aspects, size, timing, or any other applicable aspect of the respective presentation. The processor can use any of the considerations, discussed infra and supra, regarding the customer or the business entity to generate or modify the presentation. In one embodiment, the processor also uses history 116 to generate or modify the presentation.

In one embodiment, computer 142, separate from computer 108, transmits modifying rule 144 to computer 108. Computer 142 can be in location 112 (not shown) or can be in a different location. Computer 142 can be associated with a business entity associated with location 112 or can be associated with a different business entity. Connection 145 between computers 108 and 142 is any type known in the art. In another embodiment (not shown), multiple computers 142 are included and respective computers among the multiple computers can be associated with the same or different business entities. Computer 108 stores modifying rule 144 in the memory unit. The processor generates or modifies the input, the history, the price, the metric, or the presentation using rule 144. Computer 142 generates rule 144, and the processor modifies the input, the history, the price, the metric, or the presentation as described in U.S. patent application Ser. No. 12/151,043, filed May 2, 2008 and entitled “Method and System For Centralized Generation of a Business Executable Using Genetic Algorithms and Rules Distributed Among Multiple Hardware Devices.”

In one embodiment, computer 108 receives at least one modifying rule 146 from a WCD and stores the rule in the memory unit. In another embodiment, the WCD is WCD 120A. The processor generates or modifies the input, the history, the price, the metric, or the presentation using rule 146. The WCD generates rule 146, and the processor modifies the input, the history, the price, the metric, or the presentation as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, the display device for the price is a WCD, for example, WCD 120A. For example, the customer has initiated or is carrying out a transaction with the business entity using a WCD. Memory element 148 in WCD 120 stores at least one rule 150 and processor 152 in the WCD implements the presentation according to rule 150. The WCD generates rule 150, and operates on the presentation as described in U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008.

In one embodiment, the history of transactions includes at least one upsell offer 154. Any upsell offer known in the art can be included in the history. In another embodiment, the processor generates or modifies the upsell offer using the AIP. In a further embodiment, the upsell is generated as described in commonly-owned U.S. patent application Ser. No. 12/151,040: “METHOD AND SYSTEM FOR MANAGING TRANSACTIONS INITIATED VIA A WIRELESS COMMUNICATIONS DEVICE,” inventors Otto et al., filed May 2, 2008; commonly-owned U.S. patent application Ser. No. 12/151,042: “METHOD AND SYSTEM FOR GENERATING AN OFFER AND TRANSMITTING THE OFFER TO A WIRELESS COMMUNICATIONS DEVICE,” inventors Otto et al., filed May 2, 2008; commonly-owned U.S. patent application titled: “METHOD AND SYSTEM FOR GENERATING A REAL TIME OFFER OR A DEFERRED OFFER,” inventors Otto et al., filed Jul. 7, 2008; commonly-owned U.S. patent application titled: “METHOD AND APPARATUS FOR GENERATING AND TRANSMITTING AN IDEAL ORDER OFFER,” inventors Otto et al., filed Jul. 7, 2008; commonly-owned U.S. patent application titled: “SYSTEM AND METHOD FOR GENERATING AND TRANSMITTING LOCATION BASED PROMOTIONAL OFFER REMINDERS,” inventors Otto et al., filed Jul. 7, 2008; or, commonly-owned U.S. patent application titled: “SYSTEM AND METHOD FOR LOCATION BASED SUGGESTIVE SELLING,” inventors Otto et al., filed Jul. 7, 2008.

In one embodiment, history 116 includes historical information 156 regarding a purchasing history for the customer. The information can include a purchasing history with respect to the business entity discussed above or with other business entities. Alternately stated, information 156 tracks customer buying habits or tracks overall customer responses with respect to entities, such as the entity associated with location 112, or tracks individual customer buying habits or tracks customer responses. In another embodiment, information 156 includes information regarding searches previously performed by the customer using a WCD. Information 156 can be used to discern patterns or other aspects regarding purchasing activities of the customer, for example, the use of the WCD, or activities of the end users that can be useful in generating or modifying the input, the history, the price, the metric, or the presentation.

History 116 can include acceptance rates of previous offers made to the customer, or financial considerations, with respect to the first business entity, of previous offers made to the customer. Financial considerations can include any of the parameters or factors described supra or infra impacting the finances of the business entity, for example, check size, net or gross profit, or inventory reduction.

In one embodiment, data 158 regarding employees of the first business entity is stored in the memory unit and input 110 includes an identification an employee of the first business entity involved in the transaction with the customer. In another embodiment, data 158 includes historical information regarding performance of the at least one employee with respect to the business entity, for example, acceptance rates for offers presented by the employee or financial considerations, including, but not limited to, profits and revenue for the first business entity for transactions involving the employee. Data 158 can be with respect to any of the financial considerations or profit and revenue optimization factors for the first business entity described supra and infra.

In one embodiment, customers are grouped by the processor according to similarities in transaction history or other customer information, for example, using input 110 and history 116. The system generates or modifies the input, the history, the price, the metric, or the presentation for use with the grouped customers.

In one embodiment, the operations of the processor and the AIP, described supra and infra, include the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

By initiation of a transaction between the customer and the first business entity, we mean: the customer has contacted the business entity, for example, by use of a self-serve kiosk or a WCD, or by identifying themselves with a loyalty card or other identification; the business entity has contact the customer, for example, an employee of the business entity has engaged the customer to query the customer regarding a transaction, for example, a cashier in a quick serve restaurant or a waiter in a sit-down restaurant, or the business entity has sent an offer or marketing message to an WCD associated with the customer; or, the business otherwise notes the customer has become available for interaction with the business entity, for example, noting that a customer has entered a location for the business entity, for example, via a WCD in possession of the customer.

In one embodiment, the present invention employs any, all, or none of the following considerations as part of price 118, for example, by adding programming logic, self-learning, and self-adaptation as noted supra:
1. The customer, for example, using history 116. For example, the price can be made more attractive to the customer if the customer is a loyal customer or if the business entity wishes to entice the customer to purchase a good seldom ordered by the customer in the past. Previous buying habits. Proclivity to accept or reject offers of the same or other types. Customer objectives also can be considered.
2. The customer class or type. For example, the price can be made more attractive to the customer if the customer is grouped with loyal customers or if the business entity wishes to entice the customer group to purchase a good seldom ordered by the customer group in the past. Customer group objectives also can be considered.
3. Temporal parameters, such as the time of day, week, month, or year. For example, the system can reduce prices to encourage sales during times of historic low sales volume or increase prices during times of historic high sales volume.
4. The good or service involved in a past, current, or possible future transaction between the customer and the business entity. For example, prices for items with a short shelf life can be made more attractive to encourage a larger volume of orders for the items.
5. Inventory on hand. For example, prices can be reduced to encourage sale of overstocked items or can be increased to maximize profits for items in short supply.
6. Specifics of a transaction. With the use of the AIP, system 100 can automatically, dynamically, and intelligently adapt the price to any parameter associated with a particular transaction. Further, the parameters to which the system is to adapt the price can be automatically, dynamically, and intelligently selected or modified.
7. Physical parameters of the transaction process. For example: order entry device, e.g., point of sales (POS) terminal, kiosk, cell phone, PDA, laptop, IED, etc.; POS device or station, e.g., front counter, drive through, retail station, call center, location on counter, e.g., first station vs. second, third fourth or other station, etc.; output display device (e.g., customer facing display, kiosk, cell phone, PDA, laptop, IED, etc.); or in a quick serve restaurant, the price can be modified to encourage use of self-service kiosks, which may optimize revenue for the business entity, or to discourage use of a point of sales station attended by an employee.
8. Rate of sale of items. For example, prices can be increased for goods that are selling rapidly or reduced for goods that are selling slowly.
9. Reservations. For example, to encourage customers to make reservations at a sit down restaurant, prices can be reduced for orders placed by customers making reservations.
10. Regular orders. For example, based on history 116, prices at a restaurant can be reduced for items regularly ordered by a customer or prices can be reduced on items rarely ordered by a customer to encourage the customer to order the rarely ordered items.
11. People in party. Customer or customer group considerations noted supra can be applied to one or more persons in a party, for example, at a restaurant. Also, the number of persons in a party can be used, for example, lowering prices for larger parties to encourage larger parties.
12. Employee. For example, using data 158 to increase prices for offers presented by an employee with a high success rate of presenting such offers.
13. Table code. For example, increasing prices for orders placed at tables in more desirable locations.
14. Goods or services ordered. For example, modifying prices to encourage certain orders or to optimize advantages associated with certain items, such as a higher profit rate.
15. The nature of the transaction, for example, determining feasible upsells to include in an offer.
16. The location at which the transaction is occurring, for example, lowering the price to encourage patronage at a location.
17. Business Information or objectives, for example, metric 128.
18. Sponsor Information or objectives.
19. Marketing Program Type.
20. Opt In Information.
21. Payment method or terms or conditions of payment.
22. Marketing Message Contents.
23. Marketing Offer Objectives.
24. Expected or Actual System Results or tracking data.
25. System determined discounts or other incentives required to achieve desired results.
26. One or more table entries provided by one or more end users, for example, a system administrator.
27. One or more rules provided by one or more end users, for example, a system administrator.
28. One or more genetic algorithms or other AI based rules or determination methods.
29. Point within transaction, e.g., pre-order, mid-order, post order, etc.
30. Loyalty program information.
31. Current store activity, e.g., high or low volumes of transactions.
32. Line times or lengths, for example, in a quick serve restaurant. Service times, for example, in a quick serve restaurant.
33. Customer survey information.
34. Financial considerations, such as total current price/profit, total expected price/profit, regular or discounted price, gross margins, profit margins, labor rates, labor availability, marketing funds available, or third party funds available, budget.
35. Expectation of accept or reject of one or more offers at one or more price points.
36. Current, prior or expected level of dilution, gaming, fishing, accretion.
37. Business, customer, or employee target goals.
38. Current or planned local, regional or national or other marketing campaigns, including, for example, product introductions, price or other promotions, print, radio or television or other advertisements, e.g., newspaper coupon drops, etc.
39. Business, customer, sponsor, or system objectives.
40. Business, customer, sponsor, third party, or system information.
41. Any other information, data, rules, system settings, or otherwise available to the marketing system or disclosed invention or the POS system or other system designed to deliver one or more marketing messages, offers, or coupons, etc.
42. Any combination or priority ranking of any two or more of the foregoing.

In general, the use of AIP 114 (and any other artificial intelligence programs or generic algorithms discussed supra or infra) is directed to generating, modifying, or using the input, history 116, the price, the metric, or the presentation while optimizing the attainment of one or more goals established by a business entity associated with a business using the system, for example, a business entity associated with location 112, or optimizing one or more parameters associated with operations of the business entity. For example, generating, modifying, or using the input, history 116, the price, the metric, or the presentation, or performing the other operations described herein associated with rules or artificial intelligence programs, includes making a selection of one or more choices from among two or more choices that yields the best or optimized outcome or yields. Optimization or maximization can be with respect to revenues, profits, item counts, average check, market basket contents, marketing offer acceptance, store visitation or other frequency measures, or improving or optimizing speed of service inventory levels, turns, yield, waste, enhancing or optimizing customer loyalty or use of kiosks or internet or other POS devices or self service devices, use of coupons or acceptance of marketing offers, reduction or optimization of any customer or cashier or any other person's gaming, fishing, or any other undesirable action or activities or failures to act when desired, minimizing or optimizing any dilution or diversion of sales, profits, average check, minimizing or optimizing use of discounts and other promotions so as to maximize or optimize any of the foregoing desired actions, outcomes or other desired benefits, or any combination of minimizing undesired results while maximizing or optimizing any one or more of any desired results.

It should be understood that system 100 can be operated by the same business entity operating or owning a business location using the system, or can be operated by a third party different than the business entity operating or owning the business location using the system. In one embodiment, a third party operates system 100 as disclosed by commonly-owned U.S. patent application Ser. No. 11/985,141: “UPSELL SYSTEM EMBEDDED IN A SYSTEM AND CONTROLLED BY A THIRD PARTY,” inventors Otto et al., filed Nov. 13, 2007.

It should be understood that system 100 can be integral with a computer operating system for a business location, for example, location 112 or with a business entity operating the business location. It also should be understood that system 100 can be wholly or partly separate from the computer operating system for a retail location, for example, location 112, or with a business entity operating the business location.

In general, system 100, and in particular, the processor using the AI program, operates to use artificial intelligence, for example, a generic algorithm to inform or make some or all of the decisions discussed in the descriptions for FIG. 1. In one embodiment, system 100 uses one or all of the historical data noted supra, to generate, modify, or use the input, the history, the price, the metric, or the presentation, or perform the other operations described herein to attain or maximize an objective of the business entity. Factors usable to determine an objective can include, but are not limited to: customer acceptance rate, profit margin percentage, customer satisfaction information, service times, average check, inventory turnover, labor costs, sales data, gross margin percentage, sales per hour, cash over and short, inventory waste, historical customer buying habits, customer provided information, customer loyalty program data, weather data, store location data, store equipment package, POS system brand, hardware type and software version, employee data, sales mix data, market basket data, or trend data for at least one of these variables.

The discussion of the generation of executables as disclosed by commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007 is applicable to the generation, modification, or use of the input, the history, the price, the metric, or the presentation or performing the other operations described herein with respect to the AIP.

It should be understood that various storage and removal operations, not explicitly described above, involving memory unit 104 and as known in the art, are possible with respect to the operation of system 100. For example, outputs from and inputs to the general-purpose computer can be stored and retrieved from the memory elements and data generated by the processor can be stored in and retrieved from the memory.

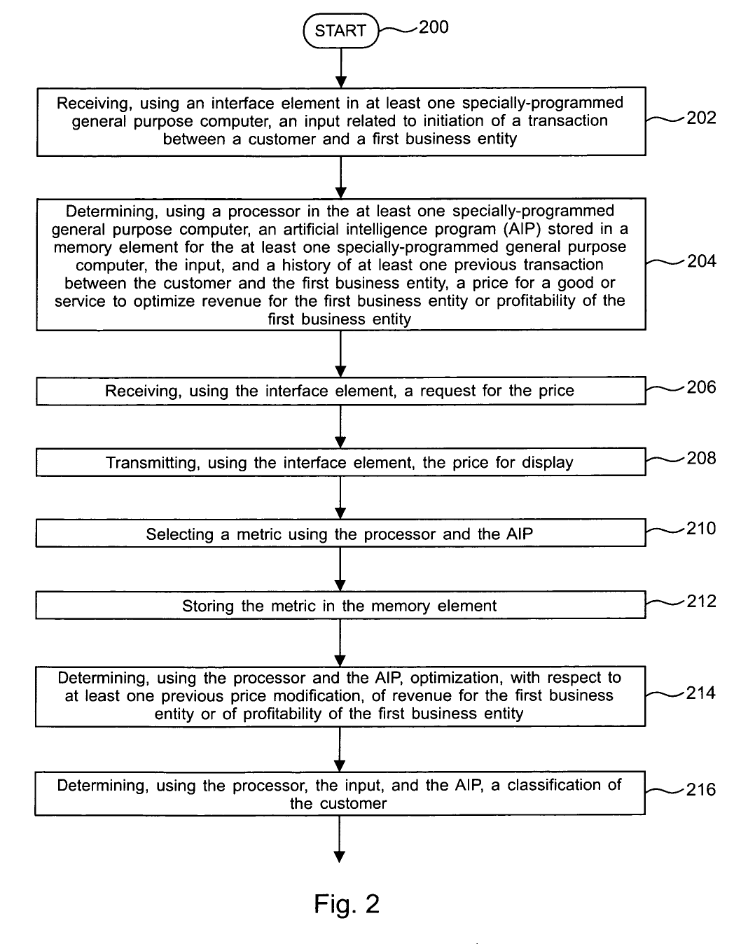

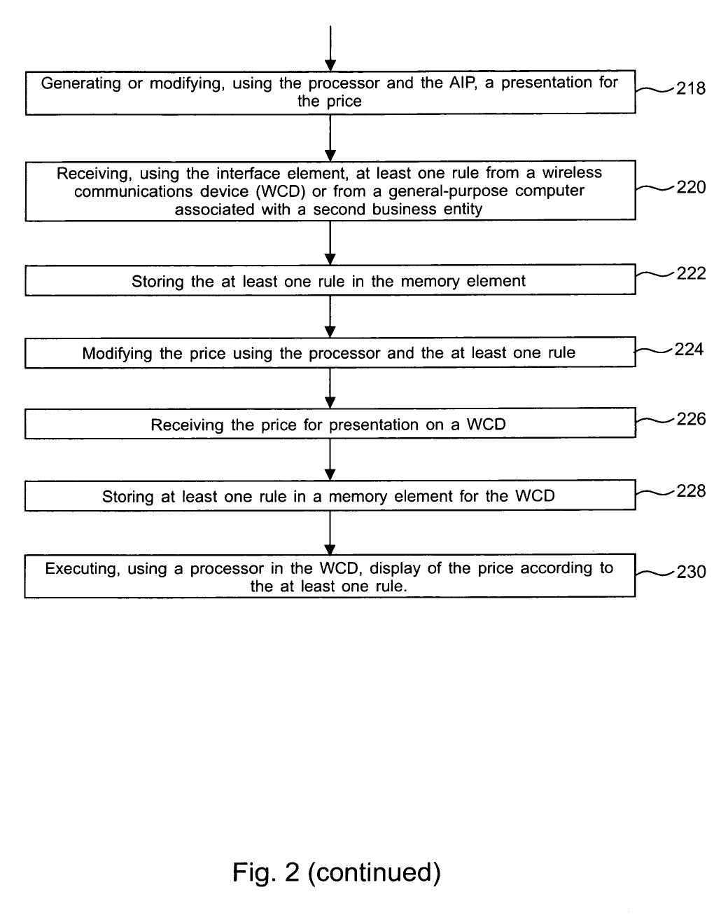

FIG. 2 is a flow chart illustrating a present invention computer-based method for managing prices in a retail environment. Although the method in FIG. 2 is depicted as a sequence of numbered steps for clarity, no order should be inferred from the numbering unless explicitly stated. The method starts at Step 200. Step 202 receives, using an interface element in at least one specially-programmed general purpose computer, an input related to initiation of a transaction between a customer and a first business entity; step 204 determines, using a processor in the at least one specially-programmed general purpose computer, an artificial intelligence program (AIP) stored in a memory element for the at least one specially-programmed general purpose computer, the input, and a history of at least one previous transaction between the customer and the first business entity, a price for a good or service to optimize revenue for the first business entity or profitability of the first business entity; step 206 receives, using an interface element, a request for the price; and step 208 transmits, using the interface element, the price for display.

In one embodiment, optimizing revenue or profitability for the first business entity includes optimizing with respect to a selectable metric stored in the memory element. In another embodiment, step 210 selects the metric using the processor and the AIP and step 212 stores the metric in the memory element. In a further embodiment, the input includes a parameter regarding the customer or a parameter regarding operation of the first business entity. In yet another embodiment, the history of at least one transaction includes at least one previous price modification for the good or service and step 214 determines, using the processor and the AIP, optimization, with respect to the at least one previous price modification, of revenue for the first business entity or of profitability of the first business entity.

In one embodiment, step 216 determines, using the processor, the input, and the AIP, a classification of the customer and determining a price includes using the classification. In another embodiment, step 218 generates or modifies, using the processor and the AIP, a presentation for the price, and transmitting the price includes transmitting data regarding the presentation. In a further embodiment, step 220 receives, using the interface element, at least one rule from a wireless communications device (WCD) or from a general-purpose computer associated with a second business entity; step 222 stores the at least one rule in the memory element; and step 224 modifies the price using the processor and the at least one rule. In yet another embodiment, the first and second business entities are the same.

In one embodiment, step 226 receives the price for presentation on a WCD; step 228 stores at least one rule in a memory element for the WCD; and step 230 executes, using a processor in the WCD, display of the price according to the at least one rule.

The following should be viewed in light of FIGS. 1 and 2. In one embodiment, for any or all of those instances of a present invention system or method in which an artificial intelligence program or generic algorithm is used, a rule or set of rules (not shown) is used in conjunction with the artificial intelligence program or generic algorithm. For example, in one embodiment, the processor uses the AIP and a rule or set of rules (not shown) stored in the memory element to generate, modify, or use the input, history 116, the price, the metric, or the presentation. The operation of an artificial intelligence program or generic algorithm with a rule or set of rules is described in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

The present invention leverages existing or future marketing systems, marketing programs, loyalty programs, sponsor programs, coupon programs, discount systems, incentive programs, or other loyalty, marketing, or other similar systems, collectively, “marketing systems” by adding programming logic, self-learning, and self-adaptation to generate or modify the input, the history, the price, or the metric; or to determine when or how to present the price. In one embodiment, in an effort to further enhance generating, modifying, or using the input, the history, the price, or the metric; or determining when or how to present the price, or to otherwise improve one or more aspects of the present invention, the invention may access certain information from existing systems, including, for example, existing POS databases, such as customer transaction data, price lists, inventory information or other in or above store, for example, location data, including, but not limited to data in a POS, back office system, inventory system, revenue management system, loyalty or marketing program databases, labor management or scheduling systems, time clock data, production or other management systems, for example, kitchen production or manufacturing systems, advertising creation or tracking databases, including click through data, impressions information, results data, corporate or store or location financial information, including, for example, profit and loss information, inventory data, performance metrics, for example, speed of service data, customer survey information, digital signage information or data, or any other available information or data, or system settings data. In one embodiment, one or more of the above operations are performed using the AIP.

In one embodiment, each location associated with the present invention establishes its own rules, uses its own AIP or generic algorithm, or learns from local employee or customer behavior or other available information. In another embodiment, the present invention shares some or all available information or results data among any two or more or all locations or locations that fall within a given area, region, geography, type, or other factors, such as menu pricing, customer demographics, etc., and makes use of such information to improve the present invention's ability to generate, modify, or use the input, the history, the price, or the metric; or to determine when or how to present the price. For example, when using an AI based system, such as disclosed in commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007,” one location may discover or otherwise determine that a certain type or class of price is particularly effective.

By sharing such information among other locations, for example, similar locations, the present invention can begin to make use of the same or similar inputs, histories, prices, metrics, or presentations in other generally similar locations or with other similar employees, types of employees, customers, or classifications of customers so as to improve the performance of one or more other such locations or all locations. In this fashion, the present invention can learn which input, history, the price, metric, or presentation more quickly or generally achieve the desired results or improve trends towards such results. Likewise, the present invention can more quickly determine which input, history, the price, metric, or presentation do not yield the desired results or determine how long such input, history, the price, metric, or presentation are required to achieve the desired results. In one embodiment, one or more of the above operations are performed using the AIP.

In a further embodiment, prices are subsidized by one or more third parties, including, for example, third party sponsors. For example, a vendor supplying an item to be priced could subsidize price to encourage acceptance of the item. In another example, such an item price may be partially or fully subsidized by an unrelated third party sponsor. For example, as part of an upsell, a telecommunications company offers to view an advertisement for telecommunications company or fill out a survey or perform some other action or accept a subsequent or related optional or required offer, etc. In one embodiment, one or more of the above operations are performed using the AIP.

In another embodiment, the present invention generates, modifies, or uses the input, the history, the price, or the metric; or determines when or how to present the prompts, offers, or surveys based upon other performance data or results. In a further embodiment, the present invention determines the impact of inputs, histories, prices, metrics, or presentations on the ability or proclivity of an employee or customer to game or fish the present invention. The system avoids or ceases inputs, histories, prices, metrics, or presentations and/or changes the type of inputs, histories, prices, metrics, or presentations provided or suppressed. In one embodiment, one or more of the above operations are performed using the AIP.

In one embodiment, inputs, histories, prices, metrics, or presentations vary from employee to employee, from customer to customer, or from time to time, and/or one or more of these may be consistent regardless of the employee, customer, or time or other information. In a another embodiment, where inputs, histories, prices, metrics, or presentations vary, such inputs, histories, prices, metrics, or presentations are determined via any applicable means and using any available information to make such determination, including, for example, any available customer, business or sponsor information or any one or more customer, business or sponsor objectives or any combination of the forgoing. In a further embodiment, inputs, histories, prices, metrics, or presentations are further determined or modified based upon information or needs or business objectives of one or more suppliers or competitors of such suppliers. For example, if a WCD is within a geographical area for a location selling competing items A and B, a price is generated and transmitted for one or both of the items and vendors for the items underwrite the cost for the price to the business entity. In one embodiment, one or more of the above operations are performed using the AIP.

In one embodiment, a present invention system generates, modifies, or uses inputs, histories, prices, metrics, or presentations based upon current or previous buying habits or any other available information regarding a customer. If for example, an end user is a loyal customer for item A, the present invention increase the price for item A or decrease the price for a different item depending upon any known factors, for example, did the customer receive or act upon an offer for item B. If the customer did receive or act upon a reminder for item B, in another embodiment, the present invention reduces a cost for item A as a blandishments to purchase item A instead of item B, or matches or beats a price for item B, or queries such loyal (or other) customer to determine what price such customer would require to purchase item A. In this fashion a competitive environment is created.

In a further embodiment, the end user of a present invention system modifies the rules or method of operation so as to favor itself. For example, in the previous example, if the producer of item A were the sole end user of the present invention, the producer may choose to not share any part or all of any such customer information or may use knowledge of any reminder regarding item B to its benefit. In another example, if a grocery chain was the sole end user of the present invention, the end user may choose to provide equal access to the present invention or favor one or more of its suppliers based upon any one or more of its business objectives, for example, the profitability or perceived or actual quality or consistency or pricing of such one or more suppliers. In one embodiment, one or more of the above operations are performed using the AIP.

In another embodiment of the present invention, past buying information is used to generate, modify, or use the input, history 116, the price, the metric, or the presentation. For example, if a retail chain knows that one or more customers in its stores have previously purchased a High Definition Television (TV) set, and the customer is identified during a transaction, the disclosed system determines that a price regarding a related product should be modified, for example, reduced to encourage purchase of the related product. In a further embodiment, the price includes specific reference to the customer or the customer's purchase of the TV set. In one embodiment, one or more of the above operations are performed using the AIP.

In one embodiment, the present invention determines a location of customer placing an order remotely, for example, using a WCD. Such determination may be made using any applicable means, including, for example, using a method of triangulation of a given WCD, such as a cell phone or PDA device. Methods to locate, within a given distance a given cell phone or other cellular device, for example, a PDA equipped with cellular communications abilities, are well known by those of ordinary skill in the art and in the prior art. By considering a customer or prospective customer's current location or by estimating a destination or route of travel, a marketing system can better determine how generate, modify, or use the input, history, price, metric, or presentation. In one embodiment, one or more of the above operations are performed using the AIP.

In one embodiment, a customer's previous buying habits, for example, as found in history 116, are used to generate, modify, or use the input, history 116, the price, the metric, or the presentation. For example, if a loyal quick service restaurant chain customer regularly visits this or other restaurants for lunch, but rarely, if ever, visits this or other quick service restaurant locations for dinner, the present invention can offer a reduced price for an item or meal if such customer visits now or at some future date during certain hours, for example, 5 pm to 11 pm. In one embodiment, one or more of the above operations are performed using the AIP.

In another embodiment, in order to receive or otherwise qualify to receive such targeted marketing messages or offers remotely, customers, that is, existing or prospective customers are required to opt in to a cellular marketing program or some other loyalty program indicating their desire or providing permission for such marketing system or company to send one or more such marketing offers or messages. In this fashion, only those interested in such communications will be sent such communications.

In one embodiment, customers identify themselves using overt actions, for example, by swiping a card, in other embodiments, in addition or in the alternative to providing such identification means overtly, such end users may identify themselves passively, including, for example, by providing a cell phone number, GPS identification number or IP address, or a license plate number. In another embodiment, the present invention uses such identification means to retrieve information about an end user, for example, customer, business or sponsor information, which information may be further used to better or optimally determine how to generate, modify, or use the input, history 116, the price, the metric, or the presentation. In one embodiment, one or more of the above operations are performed using the AIP.

In a further embodiment, prices are modified for prospective customers having an identity previously provided by an existing customer, as described in commonly-owned U.S. patent application Ser. No. 12/217,863, titled: “SYSTEM AND METHOD FOR PROVIDING INCENTIVES TO AN END USER FOR REFERRING ANOTHER END USER,” inventors Otto et al., filed Jul. 9, 2008, which application is incorporated by reference herein. For example, if an existing quick service restaurant chain customer provides one or more prospective customer's identity, when such prospective customer is identified during a transaction at a quick service restaurant chain's participating locations, the present invention generates or modifies the price or presentation of the price to attract potential customers from the program and provides the identity of the referring party along with such price. In one embodiment, one or more of the above operations are performed using the AIP.

In another embodiment, inputs, histories, prices, metrics, or presentations vary from customer to customer or from time to time, or in whole or in part are consistent regardless of the customer, or time or other information. In cases where inputs, histories, prices, metrics, or presentations vary, such inputs, histories, prices, metrics, or presentations can be determined via any applicable means and using any available information to make such determination, including, for example, any available customer, business or sponsor information or any one or more customer, business or sponsor objectives or any combination of the forgoing. Such offers or messages can be further determined or modified based upon information or needs or business objectives of one or more suppliers or competitors of such suppliers. For example, while walking through the isles of a grocery store, a customer comes upon an “end cap” or an area designed to promote one or more items or brands, and such customer receives a reduced price, for example, buy two, two liter bottles of a beverage for the price of one. Such customer may accept such price or may receive an additional price, for example, buy two, two liter bottles of a competitor's beverage and get both for the price of one, plus one additional six pack of small cans of the competitor's beverage. In this fashion, product providers or producers or retailers or distributors may provide one or more incentives to purchase one or more products, which offers may or may not be influenced by or competitive with any other such offers. In one embodiment, one or more of the above operations are performed using the AIP.

In a further embodiment, inputs, histories, prices, metrics, or presentations, are created or maintained centrally or in a distributed network, including, for example, locally. Such management may be accomplished via any applicable means available, including, for example, making use of existing, for example, off the shelf and/or customized tools that provide for such creating, management or distribution.

In one embodiment, the present invention improves results over time or with use of the invention. Such improvement or optimization can be accomplished via any means necessary including any of several methods well known in the art or as disclosed by applicants and incorporated herein by reference, including, for example, commonly-owned U.S. patent application Ser. No. 11/983,679: “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007; commonly-owned U.S. patent application titled: “METHOD AND SYSTEM FOR CENTRALIZED GENERATION OF BUSINESS EXECUTABLES USING GENETIC ALGORITHMS AND RULES DISTRIBUTED AMONG MULTIPLE HARDWARE DEVICES,” inventors Otto et al., filed May 2, 2008; and commonly-owned U.S. patent application titled: “METHOD AND APPARATUS FOR GENERATING AND TRANSMITTING AN ORDER INITIATION OFFER TO A WIRELESS COMMUNICATIONS DEVICE,” inventors Otto et al., filed May 2, 2008. For example, statistical methods can be used to determine which inputs, histories, prices, metrics, or presentations generally yield the desired or optimal or generally better results, or such results may be determined using one or more genetic algorithms, or a present invention administrator/operator can review results reports and then provide manual weighting criteria to further define or control the present invention, or a combination of these and other well known methods may be employed in any combination or in any order or priority.

In a further embodiment, a present invention price includes a discount. Such discounts can be associated or applied to specific items, or to an entire order. In one embodiment, discounts are determined based upon rules established by management of the present invention or as established or modified from time to time by any authorized personnel, or may be initially established or modified using a learning system, e.g., a genetic algorithm. In any such case, the present invention can make use of any or all available information, including, but not limited to customer information. Discounts can be designed to maximize, minimize or optimize any one or more business or customer objectives as desired or indicated. In another embodiment, the discount, if any, is presented to the customer as a percentage discount or as a cents or other amount off discount. In one embodiment, one or more of the above operations are performed using the AIP.

In one embodiment, discounts in prices are used/tried relatively sparingly to determine the price elasticity of customers, both as a whole and/or by class, group, demographics, type or order contents, base order amounts, and/or specific customer's buying habits and acceptance/rejection information. In this fashion, the present invention can, over time, yield optimal results by learning or otherwise determining what price reductions, if any, are required given the known information. For example, if customer A never orders item 1 with item 2, the present invention could include a price offering a 10% discount to combine items 1 and 2 in an order. If the customer rejects such offer, the present invention could present the same or similar price upon the next customer's order entry, but this time offer a larger discount in the price, for a 20% discount. Once the present invention determines a customer's price point, and/or the customer becomes habituated to ordering the item or service, the present invention can reduce or eliminate related discounts or other incentives. In one embodiment, one or more of the above operations are performed using the AIP.

In another embodiment, the present invention, having acquired data regarding customer price elasticity and other information, uses such information to determine other prices for the same or generally similar customers, e.g., other customers who purchase item 1 but do not typically purchase item 2. In a further embodiment, using such logic, the present invention determines classifications of customers and leverage use of such information by providing prices that are also optimized from the location or location management perspective/objectives. In one embodiment, one or more of the above operations are performed using the AIP.

In a further embodiment, an administrator can add or change or otherwise modify the previous listing, or data, or determine the order of priority or preference of each such discrimination factors or preferences or data, including, for example, location, payment or device, ranking each in order of such preference or providing table, rules or other entries to provide or assist or to support determining which are preferred or the amount of incentive available or increased or decreased incentive, as a percentage or absolute or relative or other dollar or other calculation method to determine what price modifications, if any to make, at which locations, devices or payment methods or other discriminating factors, for example, customer or business preferences or customer, business, sponsor or other entity information, objectives, rules or other available information or rules or system settings. By providing or otherwise manually or automatically determining such rankings, the disclosed invention can initially or continuously evaluate potential pricing and modify such pricing or provide other incentives to drive a desired percentage of business or customer transactions to one or more particular devices, locations or payment methods. In one embodiment, one or more of the above operations are performed using the AIP.

In one embodiment, the present invention provides such price incentives initially, or on an ongoing basis or only until certain objectives are achieved or certain customers or all customers are generally habituated to compliance, for example, with a business objective such as a minimum check size, after which, in certain embodiments, the present invention may cease, temporarily or permanently making such price incentives based upon such discriminating factors, or may reduce the difference in incentives, or may only periodically provide such full discounts or reduced discounts so as to reinforce such behavior. In another embodiment, a system administrator or other end user establishes such rules or conditions. In one embodiment, one or more of the above operations are performed using the AIP.

In a further embodiment, the present invention makes such determinations using an automated means. Such automated means includes, for example, a system that periodically or generally continuously tests different inputs, histories, prices, metrics, or presentations or other methods, for example, user interfaces, or other benefits or incentives, and based upon such testing, determine which inputs, histories, prices, metrics, or presentations or other benefits yield the desired compliance, for example, with a business objective such as a preferred payment method. Such automated system may periodically cease providing such prices once it is determined that the desired customer behavior has been established, habituated or otherwise persists without need for such continued pricing. If such system subsequently determines that the desired behavior has ceased or fallen below a desired level, such system can then reinstate appropriate pricing. When reinstating such pricing, for example, via inputs, histories, metrics, or presentations, the present invention can return to previously successful levels or can provide different inputs, histories, prices, metrics, or presentations, on a temporary, periodic or permanent basis. Such reinstatement may be provided for all customers, certain customers, classes of customers, or only those customers that have ceased or have generally reduced their frequency of desired behavior. In one embodiment, one or more of the above operations are performed using the AIP.

In a further embodiment, the present invention tests inputs, histories, prices, metrics, or presentations or providing certain pricing on a periodic basis within a single location or among a plurality of locations so as to determine the extent or requirement regarding any such inputs, histories, prices, metrics, or presentations or other benefits. For example, by testing pricing levels, the present invention can determine the level of pricing needed to attain a business goal, or such a system can further determine the extent of any gaming, dilution, diversion or accretion. By alternating offering and not offering pricing modification or by testing various levels of pricing, the present invention can better determine the optimal incentive, discount or benefits required, if any, to achieve the desired results, while minimizing or mitigating any undesirable effects of using or deploying such system. Such testing can be accomplished via any applicable or available means, including those previously disclosed by applicants herein and within the referenced applications, or randomly or using rules or Al based systems. By periodically testing or making changes to such inputs, histories, prices, metrics, or presentations or benefits, the present invention can continually strive to achieve the optimal mix and level of inputs, histories, prices, metrics, or presentations. By combining the use of one or more of a table, rules or Al based system, including, for example, as disclosed in the applications incorporated by reference herein, a more effective, responsive, adaptive, and dynamic marketing system may be developed and deployed that achieves optimal or nearly optimal results over both the short and long term.

In one embodiment, the present invention tests customers of one or more locations using discounted pricing, while maintaining the regular prices at one or more other locations. By comparing the results data from such test and control groups of locations, the present invention can better determine which price discounts are accretive or provide net benefit or are subject to gaming, fishing or other fraudulent or undesirable activities. Such testing can be performed within a single unit as well, by periodically offering such pricing to the same or similar customers or by randomly providing or not providing such pricing.

In another embodiment, the present invention makes use of a combination of such testing methodologies in order to best determine which prices yield optimal or the best results given the present invention information, parameters or any one or more customer, business, sponsor or present invention objectives. For example, the present invention tests in a single or group of stores certain new or untested prices, and, combines such test with a periodic price, for example, toggling, between offering and not offering price discounts, which toggling, may be random, 50/50, or may be intelligently determined, for example, using the AIP, based upon system information, and continue such test for a period of time, for example, one month, while comparing results of such tests with a similar number of stores in a control group, and then, switch the process, for example, test within the original control group and stop offering pricing modifications within the original test group. In this fashion the present invention determines the effects of offering and not offering pricing modifications and the effect of such pricing on customers, customer buying habits, store or business results, or any other measures, including, for example, testing for dilution, diversion, accretion, gaming or fishing. In one embodiment, one or more of the above operations are performed using the AIP.

In a further embodiment, a system administrator is able to enter or modify or delete or otherwise provide inputs, histories, prices, metrics, or presentations using an interface provided for such purposes. When establishing messages or content of inputs, histories, prices, metrics, or presentations, such administrator or other end user may be further permitted to designate which inputs, histories, prices, metrics, or presentations are to be generally used when using a particular type of communications. For example, one type of input, history, price, metric, or presentation may be designated for use when communicating via cell phone and another input, history, price, metric, or presentation used for email and still other versions for each or all of the other various methods of communications. In one embodiment, the present invention tests each input, history, price, metric, or presentation with each such communications method to determine, partially or wholly, which input, history, price, metric, or presentation yields the best or optimal results over time or based upon any available information, including, for example, any available or otherwise accessible customer, business or sponsor information or objectives or by tracking actual activities and results or changes in behavior as expected or predicted by customers or other end users or classes or categories of uses or by device, location or payment method. In one embodiment, one or more of the above operations are performed using the AIP.

In one embodiment, inputs, histories, prices, metrics, or presentations are determined or used based upon any available information including, for example, one or more or any combination of any business objectives, or customer identification, customer information, customer objectives, or customer historic data such as buying habits, tendency to accept or reject any pricing, or based upon such acceptance with or without a discount, or the amount of or type of pricing discount, willingness to accept specific items or classes of items, or whether or not such items are complementary to base order items, a usual, preferred, or last ordered items, general price elasticity as determined by prior ordering habits or those of similar customers, or classes of customers, or for a given store or location, or based upon the time of day, day of week, month, year, the weather, competitive information, such as information about current marketing campaigns, discounts, marketing offers, and like from one or more competitors. In one embodiment, one or more of the above operations are performed using the AIP.

The following is a listing of exemplary hardware and software that can be used in a present invention method or system. It should be understood that a present invention method or system is not limited to any or all of the hardware or software shown and that other hardware and software are included in the spirit and scope of the claimed invention.

1. Central System: the programs can be managed by a central system for several retailers or by a single retail system.
a. Price Display Program-displays pricing
b. Price Management Program-manages prices
c. Transaction Processing Program-processes transactions

2. Retailer
a. Price Display Program-displays pricing
b. Price Management Program-manages prices
c. Transaction Processing Program-processes transactions

3. End User Device 1-n
a. Identify Customer Program-identifies customer
b. Price Display Program-displays prices
c. Transaction Processing Program-processes transactions

The following is a listing of exemplary data bases that can be used in a present invention method or system. It should be understood that a present invention method or system is not limited to any or all of the databases shown and that other databases are included in the spirit and scope of the claimed invention.

1. Central System
a. Business Entity Database-stores information about various business entities, for example, retailers, participating in the program
b. Inventory Database-stores inventory information
c. Transaction Database-stores transaction information
c. Customer Database-stores customer information
d. Price Rules Database-stores rules for adjusting pricing
e. Order Type Database-stores information about orders that allows them to be classified into types
f. Reservations Database-stores reservation information

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A computer-based self-learning method for managing a price in a retail environment, comprising:
receiving, using an interface element in at least one specially-programmed general purpose computer, an input related to initiation of a transaction between a customer and a first business entity;
determining, using a processor in the at least one specially-programmed general purpose computer, an artificial intelligence program (AIP) stored in a memory element for the at least one specially-programmed general purpose computer, the input, and a history of at least one previous transaction between the customer and the first business entity, a price for a good or service to optimize revenue for the first business entity or profitability of the first business entity;
receiving, using an interface element, a request for the price; and,
transmitting, using the interface element, the price for display.

2. The method of claim 1 wherein optimizing revenue or profitability for the first business entity includes optimizing with respect to a selectable metric stored in the memory element.

3. The method of claim 2 further comprising selecting the metric using the processor and the AIP and storing the metric in the memory element.

4. The method of claim 1 wherein the input includes a parameter regarding the customer or a parameter regarding operation of the first business entity.

5. The method of claim 1 wherein the history of at least one transaction includes at least one previous price modification for the good or service and the method further comprising, determining, using the processor and the AIP, optimization, with respect to the at least one previous price modification, of revenue for the first business entity or of profitability of the first business entity.

6. The method of claim 1 further comprising determining, using the processor, the input, and the AIP, a classification of the customer; and,
wherein determining a price includes using the classification.

7. The method of claim 1 further comprising generating or modifying, using the processor and the AIP, a presentation for the price; and wherein transmitting, using the interface element, the price includes transmitting, using the interface element, data regarding the presentation.

8. The method of claim 1 further comprising the steps of:
receiving, using the interface element, at least one rule from a wireless communications device (WCD) or from a general-purpose computer associated with a second business entity;
storing the at least one rule in the memory element; and,
modifying the price using the processor and the at least one rule.

9. The method of claim 10 wherein the first and second business entities are the same.

10. The method of claim 1 further comprising:
receiving the price for presentation on a WCD;
storing at least one rule in a memory element for the WCD; and,
executing, using a processor in the WCD, display of the price according to the at least one rule.

11. A computer-based self-learning system for managing a price in a retail environment, comprising:
an interface element for at least one specially programmed general-purpose computer for receiving an input related to initiation of a transaction between a customer and a first business entity;
a memory unit for the at least one specially programmed general-purpose computer for storing an artificial intelligence program (AIP) and a history of at least one previous transaction between the customer and the first business entity; and,
a processor for the at least one specially programmed general-purpose computer for:
determining, using the AIP, the input, and the history, a price for the good or service to optimize revenue for the first business entity or profitability of the first business entity, wherein the interface element is for receiving a request for the price, and wherein the processor is for transmitting, using the interface element, the price for display.

12. The system of claim 11 wherein the processor is for optimizing revenue or profitability for the first business entity with respect to a selectable metric stored in the memory element.

13. The system of claim 11 wherein the processor is for selecting the metric using the AIP and storing the metric in the memory element.

14. The system of claim 11 wherein the input includes a parameter regarding the customer or a parameter regarding operation of the first business entity.

15. The system of claim 11 wherein the history of transactions includes at least one previous price modification for the good or service and wherein the processor is for determining, using the AIP, optimization, with respect to the at least one previous price modification, of revenue for the first business entity or of profitability of the first business entity.

16. The system of claim 11 wherein the processor is for determining, using the input and the AIP, a classification of the customer, and determining the price using the classification.

17. The system of claim 11 wherein the processor is for generating or modifying, using the AIP, a presentation for the price, and transmitting, using the interface element, the data regarding the presentation to the display device.

18. The system of claim 11 wherein the processor is for:
receiving, using the interface element, at least one rule from a wireless communications device (WCD) or from a general-purpose computer associated with a second business entity;
storing the at least one rule in the memory element; and,
modifying the price using the at least one rule.

19. The system of claim 18 wherein the first and second business entities are the same.

20. The system of claim 11 wherein a WCD with a processor and a memory element is arranged to receive the price and wherein the processor for the WCD is for:
storing at least one rule in the memory element for the WCD; and,
executing, using the processor in the WCD, display of the price according to the at least one rule.

21. A computer-based self-learning method for managing a price in a retail environment, comprising:
receiving, using an interface element in at least one specially-programmed general purpose computer, an input related to initiation of a transaction between a customer and a first business entity;
determining, using a processor in the at least one specially-programmed general purpose computer, an artificial intelligence program (AIP) stored in a memory element for the at least one specially-programmed general purpose computer, and the input, a price for a good or service to optimize revenue for the first business entity or profitability of the first business entity;
receiving, using an interface element, a request for the price; and,
transmitting, using the interface element, the price for display.

22. A computer-based self-learning system for managing a price in a retail environment, comprising:
an interface element for at least one specially programmed general-purpose computer for receiving an input related to initiation of a transaction between a customer and a first business entity;
a memory unit for the at least one specially programmed general-purpose computer for storing an artificial intelligence program (AIP) and a history of at least one previous transaction between the customer and the first business entity; and,
a processor for the at least one specially programmed general-purpose computer for:
determining, using the AIP and the input, a price for the good or service to optimize revenue for the first business entity or profitability of the first business entity, wherein the interface element is for receiving a request for the price, and wherein the processor is for transmitting, using the interface element, the price for display.
